(19) United States
(12) Patent Application Publication
(10) Pub. No.: US 2005/0135537 A1
(43) Pub. Date: Jun. 23, 2005

(54) Pressure vessel

(76) Inventors: Bruce Hinton, Simsbury, CT (US); Clark Candee, Irwin, PA (US); Steven Slowik, Rocky Hill, CT (US)

Correspondence Address: WESTINGHOUSE ELECTRIC COMPANY, LLC, P.O. BOX 355, PITTSBURGH, PA, 15230-0355, US

(21) Appl. No.: 10/677,130

(22) Filed: Oct. 1, 2003

Related U.S. Application Data
(60) Provisional application No. 60/415,455, filed on Oct. 1, 2002.

(51) Int. Cl. G21C 13/00

(52) U.S. Cl. 376/205

(57) ABSTRACT

Penetration nozzles extending through penetrations of pressure vessels are sealed against leakage by structural welds at the inner surface of the pressure vessel. The wall of each penetration and adjacent penetration nozzle form a passageway extending from the circumferential structural weld to the outer surface of the pressure vessel. Each passageway includes a groove machined into the penetration wall or the penetration nozzle for providing a leak path extending from the weld to the outer surface in the event that a crack develops in the weld or the heat affected zone in the penetration nozzle.

### BACKGROUND OF THE INVENTION

The invention relates to pressure vessels and more particularly to pressure vessels that are susceptible to stress corrosion cracking (“SCC”), such as those employed in commercial nuclear reactor plants.

Commercial nuclear reactor plants generate high temperature, high pressure water for ultimately driving steam turbines to generate electricity. For example, pressurized water plants are designed to operate at temperatures of approximately 600° F.-650° F. or more and at pressures of approximately 2250 psi or more. As these plants have aged after decades of substantially continuous operation, highly stressed regions of pressure vessels exposed to these high temperature, high pressure corrosive environments have proven to be susceptible to SCC. In particular, the welds of some penetration nozzles in the hemispherical pressure vessel heads (sometimes known as “J-groove” welds) and the associated heat affected zones in the penetration nozzles have started to develop cracks.

The nuclear power industry periodically inspects the pressure vessel heads in pressurized water nuclear reactor plants to detect cracking using ultrasonic or eddy current techniques. However, because of the structure and geometry of pressure vessel heads and their welds, small cracks may not be detected before they grow across the welds or through the penetration nozzle walls. Once a crack develops across the entire weld or through the heat affected zone in the penetration nozzle, the high temperature water will start to leak through the crack. Thus, the industry visually inspects the outer surfaces of the pressure vessel heads for evidence of leaking (such as residual water stains or boric acid crystals) in the course of refueling outages. However, because the typically tight fit of the penetration nozzles in the pressure vessel heads may delay leakage, a relatively long time may pass between the initiation of cracking and the visual detection of leakage. During this time, the cracking may continue to develop and existing cracks may continue to grow to the point where the pressure vessel heads can not be economically repaired but must be replaced.

### SUMMARY OF THE INVENTION

It is an object of the present invention to provide a pressure vessel design that permits cracks associated with penetration nozzle welds to be readily verified by visual inspection techniques. It is a further object to provide a design that permits leaks to be detected before cracks can substantially grow. As used herein, the word “penetration” means a hole extending through a pressure vessel wall and the expression “penetration nozzle” means a pipe or tube segment that extends through a “penetration” and is fixed to the pressure vessel wall.

With these objects in view, the present invention resides in a pressure vessel having a leak path in its pressure-retaining boundary extending from its penetration nozzle welds to its outer surface where a leak may be readily detected. A pressure vessel embodying the present invention has an inner surface (which may be exposed to a corrosive environment) and an outer surface with a plurality of penetrations defined by penetration walls extending between the inner surface and the outer surface. A plurality of penetration nozzles extend in the penetrations. Each penetration nozzle is sealed with the pressure vessel head by a circumferential structural weld at the inner surface of the pressure vessel. Each penetration wall and adjacent penetration nozzle defines a passageway extending therebetween from the circumferential structural weld outwardly to the outer surface of the pressure vessel. Each passageway includes a groove in the penetration wall or in the penetration nozzle.

### BRIEF DESCRIPTION OF THE DRAWINGS

The invention as set forth in the claims will become more apparent from the following detailed description of a preferred embodiment thereof shown, by way of example only, in the accompanying drawings, wherein:

FIG. 1 is a schematic representation of a pressure vessel having penetration nozzles extending from a hemispherical upper head;

FIG. 2 is a schematic representation of a penetration nozzle welded to the pressure vessel head of FIG. 1 in accordance with prior art designs;

FIG. 3 is a top view of the penetration nozzle of FIG. 2 taken along line 3-3;

FIG. 4 is a schematic representation of a first embodiment of the present invention depicting a penetration nozzle welded to the pressure vessel head of FIG. 1;

FIG. 5 is a top view of the penetration nozzle of FIG. 4 taken along line 5-5;

FIG. 6 is a schematic representation of a second embodiment of the present invention depicting a penetration nozzle welded to the pressure vessel head of FIG. 1;

FIG. 7 is a top view of the penetration nozzle of FIG. 6 taken along line 7-7; and

FIG. 8 is a schematic representation of a third embodiment of the present invention depicting a penetration nozzle welded to the sidewall of the pressure vessel of FIG. 1.

### DESCRIPTION OF THE PREFERRED EMBODIMENTS

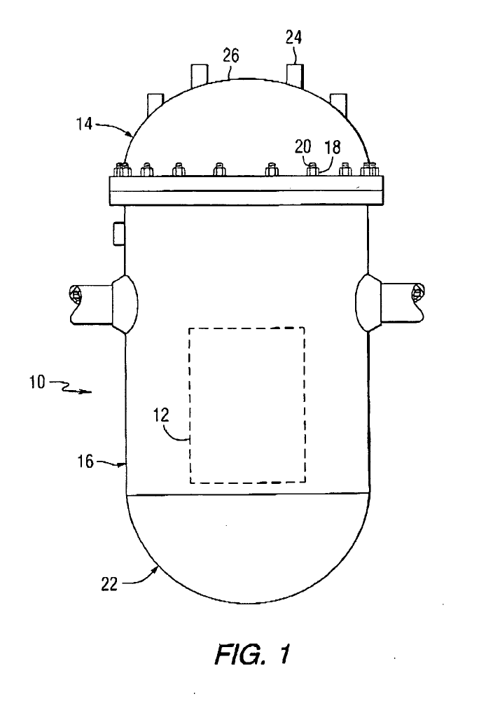

Referring now to the drawings in detail and in particular to FIG. 1 there is shown a pressure vessel 10 containing fuel assemblies 12 for transferring heat to recirculating water in a pressurized water nuclear reactor plant. The pressure vessel 10 has a hemispherical upper head 14 attached to a vessel body 16 by a plurality of nuts 18 threaded onto studs 20. The pressure vessel 10 also has a welded lower head 22. The upper head 14 has a plurality of penetration nozzles 24 extending from its outer surface 26. The penetration nozzles 24 in the upper head 14 of a pressure vessel containing fuel assemblies 12 are designed to support control rod drive assemblies (not shown) or in-core instrumentation (not shown). The lower head 22 of a pressure vessel 10 containing fuel assemblies 12 may also have penetration nozzles (not shown) for supporting additional instrumentation. The pressure vessel 10 is also representative of other pressure vessels that contain high temperature water and/or steam in pressurized water nuclear power plants such as pressurizers and steam generators and of other pressure vessels used in other plants such as boiling water nuclear reactor plants, petrochemical plants and chemical plants wherein the penetration nozzles can be employed for the same or other purposes such as supporting thermocouples and the like.

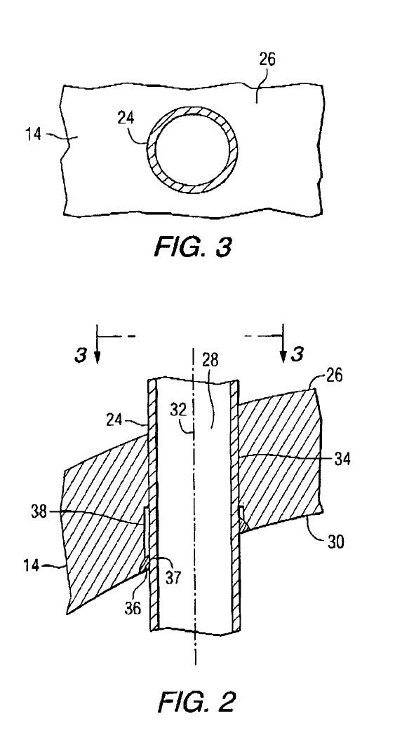

FIGS. 2 and 3 illustrate a known pressure vessel head design wherein a plurality of penetration nozzles, represented by penetration nozzle 24, extend through a plurality of penetrations, represented by penetration 28, in the upper head 14. The upper head 14 has an inner surface 30 that is exposed to high temperature, high pressure water and radiation during operation. Each penetration nozzle 24 and penetration 28 extends generally vertically along an axis 32. Each penetration 28 is generally defined by a penetration wall 34 extending between the inner surface 30 and the outer surface 26. Each penetration nozzle 24 is typically fixed in the penetration 28 by a specific interference (or a so-called “shrink fit”) with tie penetration wall 34 and sealed with the upper head 14 by a circumferential structural weld 36 at the inner surface 30 of the upper head 14. The seal is designed to be water-tight under all conditions. The structural weld 36 is designed to support the penetration nozzle 24 against all of the mechanical and hydraulic forces to which it may be exposed while in service. Typically, for a pressure vessel in a commercial nuclear reactor plant, the weld design takes no credit for the interference fit. The interference fit is intended to fix the penetration nozzle 28 in position prior to welding and then to minimize the effect of any externally applied loads on the weld. As is illustrated, each penetration 28 may have an enlarged countersunk portion 38 at the inner surface 28 of the upper head 14. In other designs, there may be no countersunk portions or there may be additional countersunk portions at the outer surface 26 of the pressure vessel 10.

As discussed above, these welds 36 and their heat affected zones 37 are subject to SSC after years of exposure to high temperature, corrosive environments. Once a crack grows across a weld 36 or through the wall of the penetration nozzle 24, the water in the pressure vessel 10 will tend to leak through the crack. However, in the prior art penetration nozzle designs illustrated by FIGS. 2 and 3, the tight interference fit may restrict the passage of leaking water for many years while the cracking becomes more extensive.

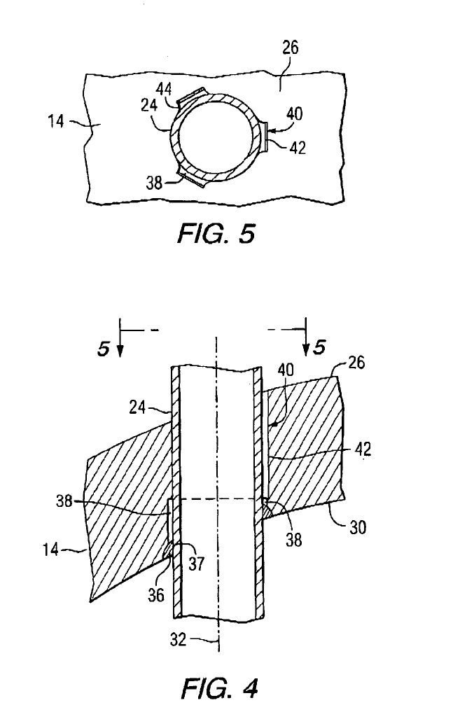

As is illustrated by FIGS. 4-8, the present invention provides a leak path extending between a penetration nozzle 24 and a penetration 28 from the weld 36 to the outer surface 26 of the pressure vessel 10 so that a leak can be readily detected in the course of a visual inspections during following outages. In pressure vessels embodying the present invention, each penetration wall 34 and adjacent penetration nozzle 24 defines a passageway extending from the weld 36 to the outer surface 26, which passageway includes at least one groove cut into the penetration wall 34 or in the penetration nozzle 24 in the interference fit region. Most preferably, the grooves are cut into the penetration walls 34. The grooves may be cut by electrical discharge machining or other suitable means.

FIGS. 4 and 5 illustrate a first embodiment of the present invention, which includes a leak path or passageway 40 extending axially from its inner end at the circumferential structural weld 36 to its outer end at the outer surface 26. As is best seen in FIG. 4, each passageway 40 may include a countersunk portion 38 at its inner end. Each passageway 40 generally includes one or more (depicted in FIG. 5 as three) grooves 42 machined into pressure vessel head 14, which extend axially from the countersunk portion 38 to the outer surface 26. In one design having three grooves 42, the grooves may be approximately a fourth of an inch wide and a sixteenth of an inch deep. Preferably, the grooves 42 will have generous radii 44. In other embodiments, the grooves 42 may be machined in the penetration nozzles 24 (not shown) rather than the pressure vessels 10. The designs may be varied to suit the capabilities of the manufacturers.

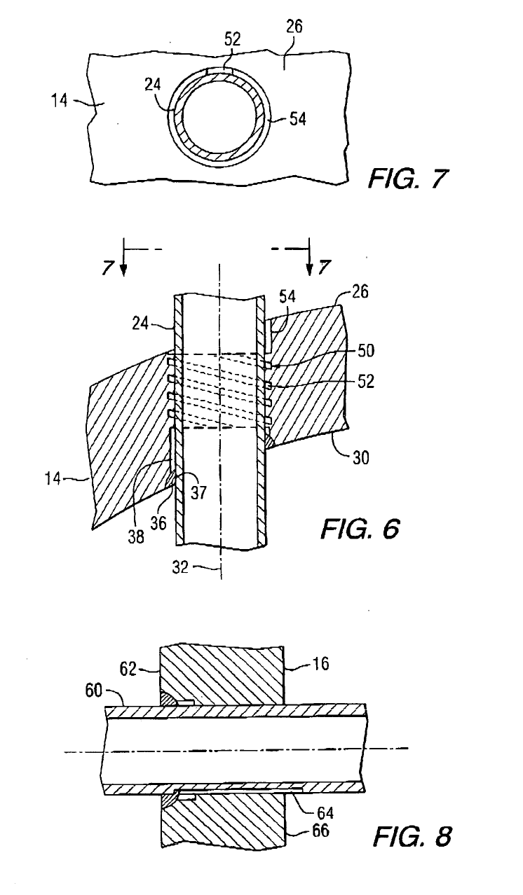

FIGS. 6 and 7 illustrate a second embodiment of the present invention, which provides a passageway 50 including a groove 52 spirally extending around the axis 32 from a counterbore 38 at its inner end to an optional countersunk portion 54 at its outer end at the outer surface 26.

FIG. 8 illustrates a third embodiment of the present invention, wherein a penetration nozzle 60 is welded to the inner surface 62 of a vertical sidewall 16 of the pressure vessel 10. As is illustrated, an axially extending groove 64 is machined into the penetration nozzle 24, which extends from the weld to the outer surface 66 of the pressure vessel 10. Preferably, the groove 64 is positioned at the bottom of the penetration nozzle 24.

While a present preferred embodiment of the present invention has been shown and described, it is to be understood that the invention may be otherwise variously embodied within the scope of the following claims of invention.

1. A pressure vessel having an inner surface and an outer surface with a plurality of penetrations defined by penetration walls extending between the inner surface and the outer surface, and a plurality of penetration nozzles extending in the penetrations and sealed with the pressure vessel by circumferential structural welds at the inner surface, wherein each penetration wall and adjacent penetration nozzle defines a passageway extending therebetween from the circumferential structural weld to the outer surface and wherein each passageway comprises a groove in the penetration wall or the penetration nozzle for providing a leak path from the weld to the outer surface.

2. The pressure vessel of claim 1, wherein each penetration nozzle has an axis and each groove extends axially along the penetration nozzle.

3. The pressure vessel of claim 2, wherein a plurality of grooves axially extend in parallel along the penetration nozzle.

4. The pressure vessel of claim 1, wherein each penetration nozzle has an axis and each groove spirally extends around the axis.

5. The pressure vessel of claim 1, wherein each passageway has an inner end defined by a counterbore.

6. The pressure vessel of claim 1, wherein each passageway has an outer end defined by a counterbore.

7. The pressure vessel of claim 1, wherein each passageway has an inner end and an outer end defined by counterbores.

8. The pressure vessel of claim 1, wherein the penetration nozzles extend through a hemispherical vessel head.

9. The pressure vessel of claim 1, wherein the penetration nozzles extend through a pressure vessel containing radioactive fuel assemblies.

10. A pressure vessel having an inner surface and an outer surface with a plurality of penetrations defined by penetration walls, the penetrations including counterbores at the inner surface and extending to the outer surface, and penetration nozzles extending in the penetrations and sealed with the pressure vessel by circumferential structural welds in the counterbores at the inner surface, each penetration nozzle having an axis, wherein each penetration wall includes a groove that extends farther from the axis of the penetration nozzle than does the counterbore.

11. The pressure vessel of Clair 10, wherein each groove has convex surfaces.

12. A pressure vessel having an inner surface and an outer surface with a plurality of penetrations defied by penetration extending from larger counterbores at the inner surface to the outer surface, and penetration nozzles extending in the penetrations and sealed with the pressure vessel by circumferential structural welds in the counterbores at the inner surface, wherein each penetration wall has a groove with convex surfaces.
